(19) United States
(12) Patent Application Publication
(10) Pub. No.: US 2009/0205473 A1
(43) Pub. Date: Aug. 20, 2009

(54) Adjustable guide pads

(76) Inventors: Lawrence Baker, (US); Michael Halterman, (US)

Correspondence Address: Sam Silverberg, 6820 32nd st. NW, Washington, DC, 20015, US

(21) Appl. No.: 12/071,172

(22) Filed: Feb. 15, 2008

(51) Int. Cl. B26D 7/04

(52) U.S. Cl. 83/425.4

(57) ABSTRACT

This invention is directed to guide pads that can be adjusted to a desired distance from the guide arm while mounted on the guide arm. The pad is machined so that the surface is level. The pad is then mounted on the guide arm and leveled using an adjustable level means to achieve the desired distance of the pad from the guide arm. By having the adjustable leveling means to adjust the guide pad, the desired distance of the pad from the guide arm can be can be maintained without shimming and machining the pad after the pad is mounted on the guide arm. With the use of an adjustable leveling means, materials harder than Babbitt can be used and readjusted to the desired distance without machining the pad. If the pad becomes so worn that the leveling means cannot adjust the pad to the desired distance from the guide arm, the pad can be removed and machined. Afterwards the machined pad can be mounted on the guide arm and leveled to the proper distance.

### FIELDS OF INVENTION

This invention relates to guide pads that can be adjusted while the guide pad is mounted on the guide arm.

### BACKGROUND OF THE INVENTION

Guides and their associated guide pads are used to control circular and/or band saw blades to minimize deviation from the cutting plane. A saw blade has a tendency to deflect under heat. U.S. Pat. No. 4,635,513, incorporated by reference in the entirety, teaches that the friction of the blade rubbing against the saw blade guide causes the heat. This reference teaches that water or oil or a mixture of oil and water can be inserted between the bearing surface of the guide plate and the saw plate to cool the saw blade. The prior art has provided a mixture of forced air, water, and oil to be distributed onto the saw blade through drilled hole in the guide while the blade is in operation. In this manner, the liquid under pressure forms a film on the guide bearing surface and acts to keeps the saw blade stable and to minimizes deflection.

U.S. Pat. No. 7,013,779, incorporated by reference in the entirety, shows the use of saw blade guide pads attached to a guide arm to form a guided blade assembly. These guided saw blade assemblies are normally comprised of a lubricating guide support assembly that includes two guide pads per saw blade each having a liquid bearing surface located immediately adjacent of each other on both sides of the saw body. Clearance between the saw blade body and guide pad can be minimal, (e.g., 0.0001 to 0.005″) but still allowing for free rotation with exception of unintentional and occasional contact with the guide pad while in use. At least one of the guide support pads includes a concave area containing pressurized liquid exposed to the saw blade body. The pressurized liquid is designed to cool the saw blade while also providing hydraulic support of equal pressure to both sides of saw blade body. The pressurized liquid acts as a liquid bearing that prevents all but occasional contact of the saw with the guide pad.

The guides are usually positioned perpendicular to an arbor and the saw blade must rotate parallel to the guides. Excessive distance between the guides will result in increased saw body deflection and increased sawing variation. Inadequate distance between the guides will cause the guide and saw body to heat and wear. The heat will distort the relatively thin saw body leading to excessive saw deviation and potential destruction of the saw.

Typically guide pads are produced from relatively soft and/or pliable materials such as Babbitt type alloys made of but not limited to tin-antimony-(nickel). The alloy is poured into a mold in the shape of the pad. The pad is then bolted to the guide arm, and machined to the finished thickness. These guide pads are able to accept occasional contact with the saw blade without causing damage to the saw blade body.

In operation a guide pad assembly uses a large volume of water under pressure to cool and support the saw blades. The high volume and pressure of the water passing through the system is known to be erosive to the soft guide pad materials. In addition, the occasional contact between the guide pad and saw blade body or cut debris such as wood fiber and saw dust traveling at a high rate of impact speed can cause damage to the pad.

The prior art has tried to use different materials to make the guide pads. Materials such as steel or other metals have not worked in the past due to the inherent friction and galling created by the metallic saw blades rubbing against the guide pads. Others in the art have tried chrome plated guide pads, bronze/Teflon pads, and ceramic guide pads.

These guide pads including the Babbitt pads are usually attached to the guide arm and then milled, machined or shaved to the desired distance from the guide arm. A spacer on the guide arm is usually used as a reference to achieve the desired distance. Any surface on the guide arm that is sufficiently flat can act as a reference. After the guide pads become worn and are no longer at the desired distance from the guide arm, they are usually discarded. The Teflon/bronze pad can be reused by shimming the pad while attached to the guide arm and then re-milling the surface. None of these pads have been shown to be an effective commercial substitute for the Babbitt guide pads.

The prior art has acknowledged that the use of Babbitt pads is a problem in the art. Babbitt pads require a special room and equipment for manufacturing and usually a dedicated person for molding the Babbitt and servicing the Babbitt pad. Babbitt pads also generate hazardous fumes during their manufacture because of the antimony contained in the alloy. Due to the softness and low heat and abrasion resistance of the Babbitt metal, the expected life of Babbitt pads is relatively short. Typically useful life is from 4 to 60 hours of operation).

The prior art has acknowledged that a longer life guide pad would solve a long felt need in the art. Replacing the Babbitt pads with pads that have a longer service life would result in a substantially economic benefit due to less sawing variation and improving recovery. The saw blade would have a limited opportunity to distort. Narrow tolerances on the distance from the guide arm to the guide pad could be expected to reduce the consumption of water and oil.

### SUMMARY OF INVENTION

This invention is directed to guide pads that can be adjusted to a desired distance from the guide arm while mounted on the guide arm. The pad is machined so that the surface is level. The pad is then mounted on the guide arm and leveled using an adjustable level means to achieve the desired distance of the pad from the guide arm. By having the adjustable leveling means to adjust the guide pad, the desired distance of the pad from the guide arm can be can be maintained without shimming and machining the pad after the pad is mounted on the guide arm. With the use of an adjustable leveling means, materials harder than Babbitt can be used and readjusted to the desired distance without machining the pad. If the pad becomes so worn that the leveling means cannot adjust the pad to the desired distance from the guide arm, the pad can be removed and machined. Afterwards the machined pad can be mounted on the guide arm and leveled to the proper distance.

The pad can be coated with a protective coating. The protective coating can be any coating that would provide a guide pad with a longer life than a Babbitt pad. Any coating harder and with at least the same degree of lubricity than the Babbitt material would be expected to work. The protective coating can be machined to provide a smoother or more level coating. This coated guided pad is then mounted on the guide arm and leveled to the desired dimension using the adjustable leveling means.

After the guide pad is leveled, the distance created between the guide pad and guide arm can be sealed with a liquid or solid gasket. This keeps the saw dust, pitch and other undesirable materials from building up between the guide arm and pad.

The lubrication port or ports allows the lubricant/water to flow into the concave portion of the guide pad. The flow of the lubricant/water can be regulated by using adjustable means such as a threaded screw or an expandable pin. To keep the lubricant/water from escaping from the pad a sealant is usually applied around the port opening.

### BRIEF DESCRIPTION OF THE DRAWING

FIG. 1 shows a guide pad with holes for adjusting the guide pad

FIG. 2 shows leveling screws and adjusting screws on a guide pad connected to guide arm.

FIG. 3 shows a guide pad mounted on a guide arm using a retaining screws that are inserted into an annular adjusting screw.

FIG. 4 shows an annular adjusting screw with a lip

### DETAILED DESCRIPTION OF THE INVENTION

The present invention provides a guide pad or a coated guide pad. Preferably the coating is an alkaline electroless nickel boron coating as described in U.S. Pat. No. 6,066,406 to McComas, granted May 23, 2000; U.S. Pat. No. 6,183,546 to McComas, granted Feb. 6, 2001; U.S. Pat. No. 6,319,308 to McComas, granted Nov. 20, 2001; and U.S. Pat. No. 6,782,650 to McComas, granted Apr. 3.1, 2004, and patent application Ser. No. ______ titled Coated Guide Pads invented by Ed McComas and Dennis Hanlon and filed on the same day of which all are incorporated by reference in their entirety. The guide pad can be made of a hard material such as but not limited to hot and cold rolled steel, aluminum, bronze, titanium, stainless steel, powdered metal, cast iron and high strength plastics. The pad can be produced from any conventional method such as but not limited to sand casting, investment casting, centrifuge casting, loss-foam casting, loss wax casting machined from billet, forged, sintered or molded

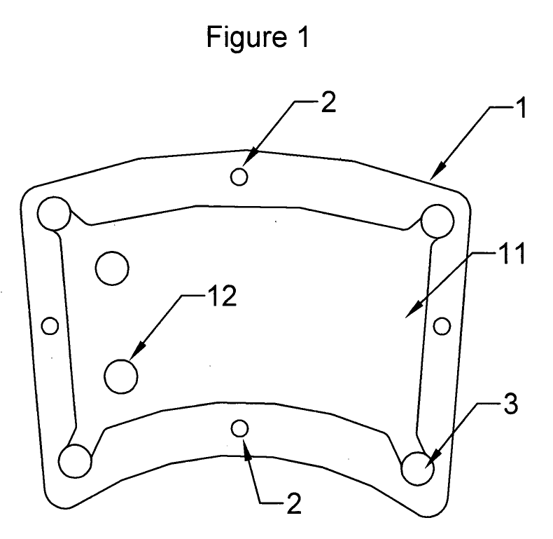

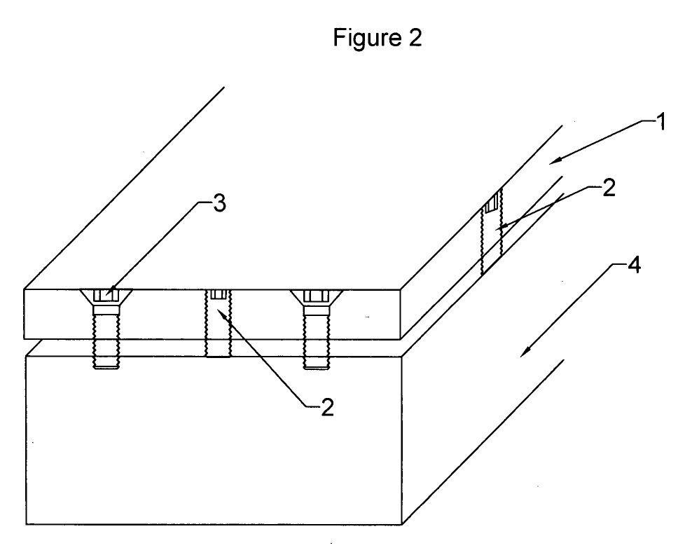

FIGS. 1 and 2 show an adjustable guide pad 1 with the adjusting leveling means. The adjustable guide pad can have a concave surface 11 and lubricating ports 12. The adjustable guide pad 1 has locking threaded screws 3 that go through an opening in the guide pad 1 and adjusting threaded set screws 2 that are screwed into a mated threaded opening in the guide pad. The adjusting set screw 2 positions the pad 1 a set distance from the guide arm 4. The guide arm 4 has means for holding the guide pad in a fixed position such as threaded holes for mating with the locking screw. FIG. 2 shows a locking screw 3 screwed into a mating threaded opening in the guide arm 4. The adjusting set screw 2 is shown screwed into a threaded opening in the guide pad 1 until it rests on the surface of guide arm 4.

By using a number of adjusting set screws the pad can be positioned and leveled within the requisite tolerance needed for a guide pad. After the guided pad is leveled, the locking screws are screwed into the mated threaded holes in the guide arm. The locking screws 3 press the pad down until the adjusting screws 2 resist the downward force. The adjusting screws should not be tightened to the point where the pad is bending. The adjusting screws and locking screws must be recessed below the surface of the pad that comes in contact with the saw blade to avoid contact with the saw blade.

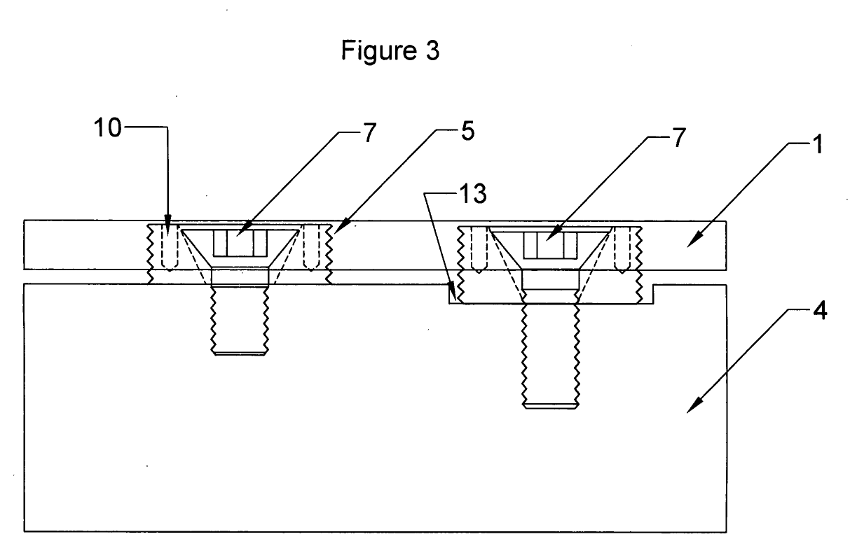

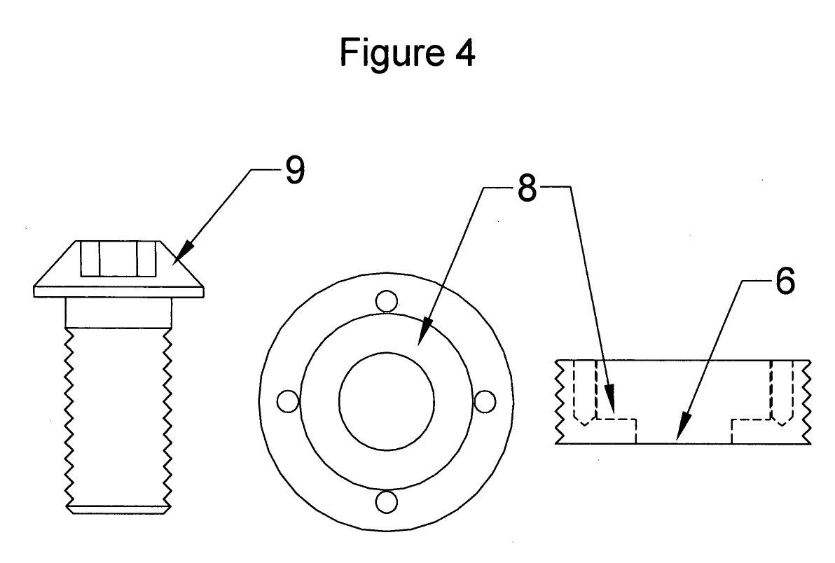

A preferred embodiment is shown in FIGS. 3 and 4 to prevent the locking screw from bending the pad. This embodiment uses an adjusting screw 5 having an annular opening 6 wherein the locking screw 7 is inserted. The annular adjusting screw 5 is screwed into the pad until the screw presses against the top surface of the guide arm. The surface of the guide arm can have recesses 13 where the annular adjusting screw contacts the guide arm. The annular adjusting screws are threaded into the pad so that the pad is level. Afterward the locking screw is inserted into the tapered annular opening and tightened. The pressure from the locking screw is transferred to the adjusting screw so that the pad 1 is not bent during tightening. The annular adjusting screw can have both inner and outer threads.

Another preferred embodiment is using an annular adjusting ring having a flat flange 8 rather than a tapered annular adjusting ring. The locking nut can be a button head allen screw 9. The annular adjusting screw can have holes 10 for turning the screw 9 into the pad.

1. A guide pad attached to a guide arm used to support saw blades having an adjustable leveling means for leveling the guide pad comprising:
a guide arm having means to attach a guide pad to the guide arm
a guide pad having recessed areas where the adjustable leveling means are located, and
an adjustable leveling means that include means for leveling the guide pad and means for locking the guide pad into a fixed level position with respect to a surface on the guide arm.

2. A guide pad attached to a guide arm according to claim 1 wherein the recessed areas of the guide pad have a threaded through hole and wherein the means for leveling the guide pad comprises a threaded adjusting screw for spacing the guide pad to a desired distance from the guide arm by screwing the threaded screw through said threaded hole
and wherein the means for locking the pad to the guide arm is a threaded locking screw that goes through the guide pad and is screwed into a mating threaded hole in the guide arm.

3. A guide pad attached to a guide arm according to claim 2 wherein the threaded adjusting screw is a set screw.

4. A guide pad attached to a guide arm according to claim 2 wherein the threaded adjusting screw has an annular opening wherein the means for locking the guide arm is inserted.

6. A guide pad attached to a guide arm according to claim 4 wherein the annular threaded screw has an annular lip inside the annular opening at one end.

7. A guide pad attached to a guide arm according to claim 4 wherein the threaded locking screw goes through the annular opening of the adjusting screw.

8. A guide pad attached to a guide arm according to claim 4 wherein the adjusting annual threaded screw is tapered at one end.

9. A guide pad attached to a guide arm according to claim 4 wherein the bottom of the annular threaded screw is recessed below the surface of the guide arm.

10. A guide pad including adjustable leveling means that can be attached to a guide arm used to support saw blades comprising:
a guide pad having recessed areas where the adjustable leveling means are located, and
an adjustable leveling means that include means for leveling the guide pad and means for locking the guide pad into a fixed level position with respect to the guide arm.

11. A guide pad including adjustable leveling means according to claim 10 wherein the means for leveling the guide pad comprises a threaded screw that is capable of spacing the guide pad to a desired distance from the guide arm by screwing the threaded screw through said threaded hole and wherein the means for locking the pad to the guide arm is a threaded locking screw that is capable of being inserted through the guide pad and being screwed into a mating threaded hole in the guide arm

12. A guide pad including adjustable leveling means according to claim 11 wherein the treaded adjusting screw is a set screw.

13. A guide pad including adjustable leveling means according to claim 11 wherein the threaded adjusting screw has an annular opening and wherein the means for locking the guide pad to the guide arm can be inserted.

14. A guide pad including adjustable leveling means according to claim 13 wherein the annular threaded adjusting screw is tapered at one end.

15. A guide pad including adjustable leveling means according to claim 13 wherein the annular threaded adjusting screw has an annular lip inside the annular opening at one end.

16. A guide pad including adjustable leveling means according to claim 13 wherein the threaded locking screw can be inserted through the annular opening of the adjusting screw.

17. An adjustable leveling means comprising,
an annular threaded adjusting screw and,
a machined locking screw that can be inserted into the annular adjusting screw.

18. A process of mounting a guide pad onto a guide arm comprising,
providing a guide arm having threaded holes to attach the guide pad to the guide arm
providing a guide pad having recessed areas where an adjustable leveling means are located,
and wherein the recessed areas of the guide pad has a threaded through hole
providing an adjustable leveling means that include an adjustable screw for leveling the guide pad and a locking screw for locking the guide pad into a fixed level position with respect to the guide arm,
leveling the guide pad by screwing the adjustable screw in the guide pad's threaded through hole until the desired distance from the guide arm is reached, and
locking the guide pad to the guide arm by inserting a locking screw through the guide pad and screwing the locking screw into a mating threaded hole in the guide arm.

19. A process according to claim 18 wherein the adjustable screw is an annular threaded adjusting screw having an opening and wherein locking screw is inserted in the opening and is screwed in the guide arm to lock the guide to the guide arm.
